(19) United States
(12) Patent Application Publication
(10) Pub. No.: US 2024/0292806 A1
(43) Pub. Date: Sep. 5, 2024

(54) Blended Cat Litter

(71) Applicant: Stephanie Gandy Murphy, Dallas, TX (US)

(72) Inventor: Stephanie Gandy Murphy, Dallas, TX (US)

(21) Appl. No.: 18/115,879

(22) Filed: Mar. 1, 2023

(51) Int. Cl. A01K 1/015

(52) U.S. Cl. CPC A01K 1/0155

(57) ABSTRACT

Disclosed in the present a formulation of Bentonite clay blended with Sorghum grass seed and packaged in a multilayered paper bag with a handle for easy of carrying. The blended litter is suitable for domestic cats. Natural bentonite is known for clumping cat litter for happy and clean cats thereby preventing bacteria and odour from taking over the cat's litter. Litter compositions are provided comprising sodium bentonite and various fillers. These litter compositions have substantially the same clumpability properties as a composition consisting of only the sodium bentonite.

### FIELD OF THE INVENTION

The present invention relates to the field of kitty litter, and in particular to a formulation of Bentonite clay blended with Sorghum grass seed and packaged in a multilayered paper bag with a handle for easy of carrying.

### BACKGROUND

There are many different types of litters on the market. Most of them are using single ingredient such as silica, benzoate clay, corn, ground walnut, and grass seeds. Many cats prefer Benzoite clay but it can be extremely dusty and heavy for elderly clients to carry home for their cats. This litter type also varies in texture. Many cats love the soft texture of grass seed but it is not as satisfying for them to dig into this litter in a box because it is so light in weight.

There is dire need to combine the two material that have the clumping capacity of both products. The grass seed allows user not to use as much of the heavy clay but still gives the cat the satisfaction of digging in the litter to cover. The present invention has been tested and works effectively.

Over time, clay has been used as animal litters clumping material for absorption. The clump strength of clay litters containing equal or greater than ninety percent sodium bentonite are strong enough to form a clump shape on contact with moisture, and hold and retain the shape on scooping without pieces of the litter breaking off of the clump, so the clump may be fully removed from a litter box. However, sodium bentonite clay is a limited resource and is also very heavy, and therefore difficult and costly to handle, package and transport. Other performance amendments used for litters may also be expensive.

As such, animal litters that include lighter materials and minimize the use of clay and other performance amendments, while still providing good clumping performance, may be desirable. It also may be desirable to use renewables in the formation of the animal litter, such as renewable starting materials to form the litter. The process for forming the litter often results in these performance amendments being dispersed throughout the litter product where they are not as effective. Thus, it may be desirable to form a product which maximizes the effectiveness of the performance amendment. Additionally, it may be desirable to provide positive scent delivery to reduce malodor.

A few patent prior art exists in the field of cat litter.

The US patent publication U.S. Pat. No. 5,188,064A of 1991 Oct. 7 discloses a clumping cat litter. The prior art invention provides a method of increasing the sorption capacity of smectite clays which exhibit osmotic swelling such as montmorillonite clays having predominately sodium as the exchangeable cation. The invention further provides a clumping cat litter having excellent cohesiveness comprising certain mixtures of a clay which exhibits osmotic swelling, a cellulosic material, and optionally a density controlling material, the clay, the cellulose material, and the density controlling material having certain particle size distributions, and the cat litter having a bulk density in the range from about 0.54 to about 0.96 g/cc and a sorption capacity greater than about 1.0 cc/g, wherein the concentration of the smectite clay is such that upon wetting the litter the cohesiveness of the lump of wetted litter is sufficient to allow its removal from a litter box, and wherein the concentration of the smectite clay is insufficient to prevent the lump of wetted litter from disintegrating in water over time.

However, whereas the above prior art discloses a method of clumping cat litter by increasing the sorption capacity of smectite clays (clay minerals that have a three-layer crystalline structure (one alumina and two silica layers), it fails to disclose blending bentonite clay with sorghum grass seed as proposed in the present invention.

The US patent publication number U.S. Pat. No. 6,860,233B2 of 2001 Feb. 3 discloses litter for cats and small animals. Litter for cats and small animals often consists of a mixture from dried material of plant origin and an adjuvant that promotes agglomeration when the mixture is exposed to moisture. The invention relates to a novel litter that is characterized in that the dried material of plant origin is present in a particle size range in which the diameters of 80% of the particles, based on the mass, range from more than 0 μm to less than 1000 μm. The mass sum distribution of the particle size distribution, at least in the range between 50 μm and 1000 μm, is larger than an integrated statistical Gaussian distribution at which the Gaussian distribution is a normal Gaussian distribution with an average value of 100 μm and a standard deviation of 800 μm and at which the particle size distribution deviates by more than 10% from this statistic Gaussian distribution. However, while above prior art presents a litter for cats and small animals consisting of a mixture of dried material of plant origin and an adjuvant, the proposed invention presents a specific cat litter comprising Bentonite clay blended with Sorghum grass seed.

To date, no one has blended two different type of products to package and sell as one.

None of the existing prior art has attempted to teach the subject matter being taught in the present invention. Consequently, there is exists a need in the field of kitty litter to formulate a better small animal litter that is light and void of odour.

As will be seen from the subsequent description, the preferred embodiments of the present invention overcome all the shortcomings of the prior art.

### OBJECTS OF THE INVENTION

The main object of the present invention is to avail a novel formulation process of cat litter having Sorghum grass seed blended with Bentonite clay.

The other object is to provide a method of deodorizing animal wastes, comprising excreta from pets, such as cats.

### SUMMARY OF INVENTION

The present in invention discloses a novel formulation of Bentonite clay blended with Sorghum grass seed and packaged in a multilayered paper bag with a handle for easy of carrying.

The blended litter is suitable for domestic cats. Natural bentonite is known for clumping cat litter for happy and clean cats thereby preventing bacteria and odour from taking over the cat's litter.

To the accomplishment of the above and related objects, this invention may be embodied in the form illustrated in the accompanying drawings, attention being called to the fact, however, that the drawings are illustrative only and that changes may be made in the specific construction illustrated and described within the scope of the appended claims.

### BRIEF DESCRIPTION OF FIGURES

Various embodiments of the present invention may be illustrated as an example and are not limited by the figures of the accompanying drawings, in which like references may indicate the same or similar elements in different or similar views, and wherein:

FIG. 1 is a diagram of blended cat litter in a package as described in the present invention.

These and other features, and advantages of the present invention will become apparent from the following detailed description, and the appended claims.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another.

The terminology used herein is for the purpose of describing the certain embodiments of the invention, some embodiments may be accompanied by drawings, others may not. The invention may be embodied in different forms; the information is not intended to be limiting of the invention. As used herein, the term and/or includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising” when used in this specification, specify the presence of the stated features, steps, operations, elements, and/or components, but do not preclude the presence or addition of one or more other features, steps, operations, elements, components and groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Where the definition of terms departs from the commonly used meaning of the term, applicant intends to utilize the definitions provided below, unless specifically indicated. For purposes of the present invention, it should be noted that the singular forms, “a,” “an” and “the” include reference to the plural unless the context as herein presented clearly indicates otherwise.

For purposes of the present invention, directional terms such as “top,” “bottom,” “upper,” “lower,” “above,” “below,” “left,” “right,” “horizontal,” “vertical,” “up,” “down,” etc., are merely used for convenience in describing the various embodiments of the present invention. The embodiments of the present invention may be oriented in various ways. For example, the diagrams, apparatuses, etc., shown in the drawing FIGURES may be flipped over, rotated by 90° in any direction, reversed, etc.

For purposes of the present invention, a value or property is “based” on a particular value, property, the satisfaction of a condition or other factor, if that value is derived by performing a mathematical calculation or logical decision using that value, property or other factor. For purposes of the present invention, the term “blend” refers to a uniform or substantially uniform mixture of two or more solid materials. One or more materials in a blend may be coated.

For purposes of the present invention, the term “cellulose-containing material” refers to a material in which more of the material is comprised of cellulose. Examples of cellulose-containing materials include paper, wood, seeds, fibers, etc. Examples of suitable seeds and grains for use as filler material include grass seeds and grains such as Sorghum, barley, rice, wheat, corn, maize, etc., pieces and parts thereof, reconstituted parts thereof and mixtures thereof.

For purposes of the present invention, the term “clumping additive” refers to a clumping agent other than sodium bentonite. For purposes of the present invention, the term “clumping agent” refers to a material that increases the clump strength of a litter material. Examples of clumping agents include sodium bentonite, xanthan gum, guar gum, etc.

For purposes of the present invention, the term “clump strength” refers to the numerical value of average clump strength for a clump of litter material formed by exposing the litter material to a wetting agent approximating urine. The clump strength of a litter material may be determined using one of the clump strength test procedures described below.

For purposes of the present invention, the term “filler” and the term “filler material” refer to a material in a litter product other than a clumping agent, i.e., other than sodium bentonite or a clumping additive. In one embodiment of the present invention, a filler material may be bentonite. In one embodiment of the present invention, the filler material may be a Sorghum grass cellulose-containing material.

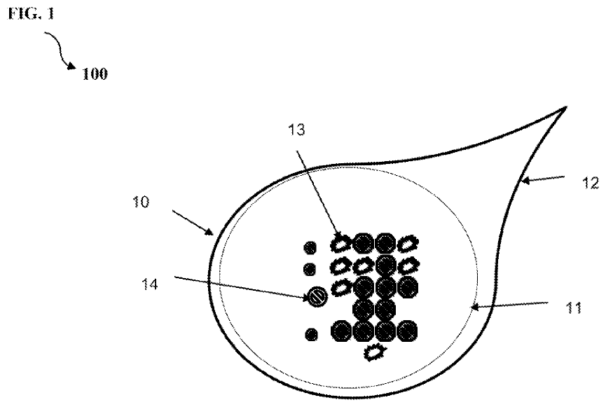

In one general embodiment according to FIG. 1, the invention presents a diagram of blended cat litter 100 in a package comprising inner layer 11 covered by the outer layer 10. The formulation further comprises a Benzoate clay 13 mixed or blended with Sorghum grass seed 14 among other features (not shown).

The present in invention discloses a novel formulation of Bentonite clay blended with Sorghum grass seed and packaged in a multilayered paper bag with a handle for easy of carrying.

The blended litter is suitable for domestic cats. Natural bentonite is known for clumping cat litter for happy and clean cats thereby preventing bacteria and odour from taking over the cat's litter.

The invention teaches of blending of two different types of litter products formulating a proprietary blend composed of Benzoite (Bentonite) clay and Sorghum grass seed. The packaging will be in a multilayer paper bag (“feed bag” style) with a handle for easy carrying.

There are many different types of litters on the market. Most of them are using single ingredient such as silica, benzoate clay, corn, ground walnut, and grass seeds.

Many cats prefer Benzoite clay but it can be extremely dusty and heavy for elderly clients to carry home for their cats. This litter type also varies in texture. Many cats love the soft texture of grass seed but it is not as satisfying for them to dig into this litter in a box because it is so light in weight.

By combining the two we have the clumping capacity of both products, the grass seed allows user not to use as much of the heavy clay but still gives the cat the satisfaction of digging in the litter to cover. The present invention has been tested on 6 cats so far and they all return to the blended litter

The present invention is not limited to the embodiments described above. Various changes and modifications can, of course, be made, without departing from the scope and spirit of the present invention. Additional advantages and modifications will readily occur to those skilled in the art. Accordingly, various modifications may be made without departing from the spirit or scope of the general inventive concept as defined by the appended claims and their equivalents.

It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

### INDUSTRIAL APPLICATION

The present invention applies animal litter industry. It introduces a formulation comprising Sorghum grass seed blended with Bentonite clay. The resultant litter is packaged in a multilayered paper bag with a handle for easy of carrying.

While the present invention has been disclosed with references to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A blended cat litter, comprising:
a. Sorghum grass seed as fillers, and
b. Bentonite clay blended with Sorghum grass seed.

2. The cat litter according to claim 1, wherein the Bentonite clay further comprises sodium bentonite with clumping properties.

3. The cat litter according to claim 1, wherein the said blend is packaged in a multilayered paper bag.

4. The cat litter according to claim 2, wherein the said bag further comprises a handle for easy of carrying.

5. The cat litter according to claim 1, wherein the blended litter is suitable for domestic cats.

6. The cat litter according to claim 1, wherein the natural bentonite is formulated to assist in clumping cat litter for happy and clean cats.

7. The cat litter according to claim 6, wherein the said clumping effect aides in preventing bacteria and odour from taking over the cat's litter.

8. The cat litter according to claim 6, wherein the said clumping effect aides in preventing the odour from taking over the cat's litter.
